(19) United States
(12) Patent Application Publication
(10) Pub. No.: US 2023/0221226 A1
(43) Pub. Date: Jul. 13, 2023

(54) METHOD FOR ESTIMATING THE SERVICE LIFE OF FLEXIBLE PIPES UNDER CO2 CORROSION IN OIL PRODUCTION

(71) Applicants: Petróleo Brasileiro S.A. - Petrobras, Rio de Janeiro (BR); Universidade Federal Do Rio De Janeiro - UFRJ, Rio de Janeiro (BR)

(72) Inventors: George Carneiro Campello, Rio de Janeiro (BR); Luis Volnei Sudati Sagrilo, Rio de Janeiro (BR); Thiago Angelo Gonçalves De Lacerda, Rio de Janeiro (BR); Tiago Brun Coser, Rio de Janeiro (BR); Rodolfo Figueira De Souza, Rio de Janeiro (BR)

(21) Appl. No.: 18/067,155

(22) Filed: Dec. 16, 2022

(30) Foreign Application Priority Data
Dec. 16, 2021 (BR) 10 2021 025511 0

(51) Int. Cl. G01N 3/08; G01N 19/08

(52) U.S. Cl. CPC G01N 3/08; G01N 19/08; G01N 2203/0066; G01N 2203/0073

(57) ABSTRACT

The invention consists of a methodology for calculating the service life of flexible tubes subject to the SCC-CO₂ phenomenon, in which the methodology allows establishing the criticality level of each duct within the scope of the phenomenon, allowing the establishment of actions for the most critics. In addition, another important gain with the development of the methodology is related to the fact that it enables safe operation even in a degraded pipe.

### CROSS-REFERENCE TO RELATED APPLICATION

This application claims priority to Brazilian Application No. BR 10 2021 025511 0, filed on Dec. 16, 2021, and entitled “METHOD FOR ESTIMATING THE SERVICE LIFE OF FLEXIBLE PIPES UNDER CO2 CORROSION IN OIL PRODUCTION,” the disclosure of which is incorporated herein by reference in its entirety.

### FIELD OF THE INVENTION

The present invention consists of a methodology for calculating the service life of flexible pipes subject to CO2-SCC phenomenon. Due to the fact that the methodology takes the operational parameters of the pipes into account, it is then possible to establish the criticality level of each pipe within the scope of the phenomenon, allowing the establishment of actions for the most critical cases. Furthermore, another important gain with the development of the methodology is related to the fact that it provides for safe operation even though the pipe is affected by the mechanism (i.e., subjected to CO2-SCC).

### DESCRIPTION OF THE STATE OF THE ART

Unbonded flexible pipes can be defined as flexible structures connected to offshore platforms for the transport of fluids (hydrocarbons, gas or water) and have been widely used in oil production at deep sea waters over the last three decades. These structures are designed in accordance with API Spec 17J and API RP 17B standards, having scaffolds (structural layers) usually built of carbon steel and carbon-manganese, which are confined in the annulus between two permeable polymeric layers.

The first for isolation of the fluid conveyed inside the pipe and the second for isolation from the external environment. Scaffolds can be susceptible to corrosion from corrosive gases (CO₂ and H₂S) and water that permeates from the inside of the pipe through the barrier polymer.

The eventual loss of tightness of the outer layer also results in the presence of water in the annulus. Also, new operating conditions, such as those found in the Brazilian pre-salt, have led to the discovery of new failure modes, which were not originally contemplated by current regulations.

In mid-2016, during an offshore operation to collect a flexible pipe, a rupture of wires in the tensile armature responsible for the support capacity of the tensile loads of the pipeline was identified.

In light of the incident, Petrobras set up an investigation team to assess the main cause of the failure and outline a strategy to define the scope and mitigating measures for the issue. Considering the results found in the evaluation of the pipe life cycle, in the dissections, analyzes of laboratory tests and bibliographical research, it was concluded that the failure was a consequence of a cracking phenomenon assisted by CO₂-activated medium in the annulus, which is described as CO₂ stress corrosion, see FIG. 2.

The presence of water in the annulus can occur due to damage to the outer sealing layer, due to failure of the outer seal in the connector or due to the permeation of water produced in the case of production pipelines. Permeation of gases takes place, mainly, from the fluid drained through the pressure barrier, which, for materials susceptible to the failure mechanism (as is the case of metallic materials used in flexible pipes), can cause failure by CO2-SCC.

One of the main impacts of CO2-SCC on flexible pipes is the reduction in the maximum permissible operating time for these pipes, which directly affects the process of integrity management, the scheduling of periodic inspections and the guarantee of operational compliance. Thus, this new failure mechanism leads to the need for the development of integrity assessment methodologies.

Upon performing a search in the state of the art, three documents that are the closest to the present invention were found.

Document CN109977511A discloses a method to predict the long-term service life of a plastic pressure pipe based on artificial intelligence. The method consists of: collecting a large number of failure cases of plastic pressure pipes; obtaining through experiments mechanical property parameters of a typical plastic pipe material under pressure; extracting basic parameters that affect the service life of plastic pipes under pressure, such as initial crack length, fatigue stress amplitude, pre-stress of the extrusion injection mold, surface scratches, and so on; taking a basic parameter that affects the service life of the plastic pressure pipe as an input parameter, a failure mode and a remaining service life as an output parameter, forming a large data analysis file; through WEKA data analysis software, selecting different algorithms for data mining analysis and obtaining the predicted failure mode and the remaining service life; comparing the prediction results of different algorithms, and selecting a suitable prediction algorithm for plastic pressure pipes; the failure mode of plastic pressure pipes and the remaining service life are predicted according to the selected algorithm. It is said in the document in question that stress corrosion is a type of failure analyzed in the method to predict the pipe's service life. The document differs from the invention in that it does not disclose a method for predicting the service life of a flexible pipe subjected to CO₂ stress corrosion.

Document CN109781611B refers to quantitative evaluation method for stress corrosion cracking of a pressurized water reactor main pipeline of a nuclear power station for long-term service. The method consists of: carrying out multiple sets of thermal aging experiments at 300-400° C. on stainless steel materials of pressurized water reactor pipelines and welded portions thereof at different temperatures for different times, ensuring the same thermal aging degree for each group of experiments; obtaining, according to a thermal aging activation empirical equation, an equation of a same material on which thermal aging of different times at two different temperatures is performed; calculating thermal activation parameters such as thermal aging activated energy, and establishing an equivalent quantitative evaluation prediction model of the thermal aging degree; constructing a thermal aging and stress corrosion coupled aging life prediction model; and evaluating stress corrosion cracking of the stainless steel materials of the nuclear power station pressurized water reactor pipelines and welded portions thereof in a service environment. The method of the invention can quantitatively predict an SCC crack initiation and extension behavior of the nuclear power plant pressurized water reactor main pipeline after long-term service and ensure safety of the nuclear power station. The document does not disclose a method for predicting the service life of a flexible pipe subjected to CO₂ stress corrosion.

Document U.S. Ser. No. 10/380,278B2 discloses a method and apparatus for analyzing potential corrosion for a vehicle, where potential corrosion surfaces for the vehicle are identified using a model for the vehicle. The steps of the method defined in D3 are: identifying potential corrosion surfaces for the vehicle using a model for the vehicle; predicting the corrosion risks for each of the potential corrosion surfaces; aggregating the predicted corrosion risks into an aggregated corrosion risk group for a group of functional design units in the vehicle; generating a corrosion risk assessment for the vehicle to identify a corrosion risk on the vehicle from the group of aggregated corrosion risks and enabling a change in the model to reduce the identified corrosion risk, where the corrosion risk assessment for the vehicle is the feedback for changes to the model for the vehicle; changing vehicle model according to risk assessment to reduce corrosion risks. The document in question discloses that an artificial intelligence algorithm can be used to predict the risk of corrosion on surfaces, but there are no further details on how the prediction is carried out by such algorithm.

The design of flexible pipes, see FIG. 1, is performed by checking whether each layer meets the design criteria for a given failure mode and its corresponding failure mechanism. Historically, one of the main concerns concerning the integrity of flexible pipes has been the extreme static loads as well as the dynamic loads that are imposed on tensile and pressure reinforcement wires.

The process of managing the integrity of flexible pipes is closely associated with the expected service life for these structures considering different failure mechanisms. Traditional design methodologies for flexible pipes (that is, based on applicable standards in force) did not take into account the presence of cracks in the structural layers and, accordingly, were not adequate for assessing the structural integrity of flexible pipes subjected to the SCC-CO₂.

The non-existence of a methodology capable of predicting the service life of flexible pipes subjected to this phenomenon makes it impossible to differentiate between more critical and less critical pipes. This fact causes a relevant impact on offshore operations by increasing the number of required inspections and increasing the associated operational risk, for example.

In view of the difficulties present in the state of the art, a method has been proposed to predict the service life of flexible pipes subject to the phenomenon of stress corrosion cracking (SCC) in oil production and additionally implement artificial intelligence algorithms for said prediction of service life.

### OBJECT OF THE INVENTION

The object of the invention consists of providing a methodology for calculating the service life of flexible pipes subjected to the CO2-SCC phenomenon, wherein the methodology allows the establishment of the criticality level of each pipe within the scope of the phenomenon, allowing the establishment of actions for the most critical cases.

Another object of the invention is to enable, through this methodology, the safe operation of flexible pipes, even if the tube is affected by the mechanism.

The invention may be applied to flexible pipes that are subjected to the CO2-SCC phenomenon. One of the main impacts of CO2-SCC on flexible pipes is the reduction in the maximum permissible operating time for these pipes, which directly affects the process of integrity management, the scheduling of periodic inspections and the guarantee of operational compliance.

### BRIEF DESCRIPTION OF THE INVENTION

The present invention discloses a method for predicting the service life of flexible pipes subjected to the phenomenon of CO₂ stress corrosion. To this end the following are used: the operational history of the flexible pipe, data on the structure of the flexible pipe, loads used for managing the structural integrity, the method for calculating the crack growth using artificial intelligence techniques and the method for calculating critical cracks.

### BRIEF DESCRIPTION OF THE DRAWINGS

The present invention will be described in more detail below, with reference to the attached figures which, in a schematic and non-limiting manner of the scope of the invention, represent examples of embodiments. In the drawings:

FIG. 1 illustrates the traditional inner layers of unbounded flexible pipes;

FIG. 2 illustrates schematically the permeation of CO₂ into layers that represent the annulus;

FIG. 3 represents schematically the crack growth by CO2-SCC as a function of time;

FIG. 4 shows an overview of the variables that affect the crack growth rate by CO2-SCC;

FIG. 5 shows an overview of the alternative variables alternative that affect the crack growth rate by CO2-SCC;

FIG. 6 illustrates an scheme for obtaining the multivariable equation for the AI algorithm crack growth rate;

FIG. 7 shows a flowchart of the general calculation for estimating the service life of flexible pipes subjected to the CO2-SCC phenomenon, once the model (multivariable equation) is defined for a given structural layer (tensile or pressure armature, for example);

FIG. 8 shows step 1 of the method in detail;

FIG. 9 illustrates in detail the achievement of the multivariable equation for predicting the crack growth rate due to CO2-SCC. Such an equation is used in step 2;

FIG. 10 illustrates the deformation process imposed on the tensile armature wires during the manufacture of flexible pipes, as adapted from U. S. Fernando, M. Davidson, K. Yan, M. J. Roy, T. Pirling, P. J. Withers e J. A. Francis, “Evolution of Residual Stress in Tensile Armour Wires of Flexible Pipes During Pipe Manufacture,” Proceedings of the International Conference on Offshore Mechanics and Arctic Engineering (OMAE), 2017;

FIG. 11A illustrates the tensile stress fields acting on the structural layer wire of a flexible pipe after seating on the tubular body;

FIG. 11B illustrates the tensile stress fields acting on the structural layer wire of a flexible pipe during FAT;

FIG. 11C illustrates the tensile stress fields acting on the structural layer wire of a flexible pipe after FAT and subjected to operational loading;

FIG. 12A shows comparisons between the actual and predicted crack sizes for tensile armature; and

FIG. 12B shows comparisons between the actual and predicted crack sizes for pressure armature.

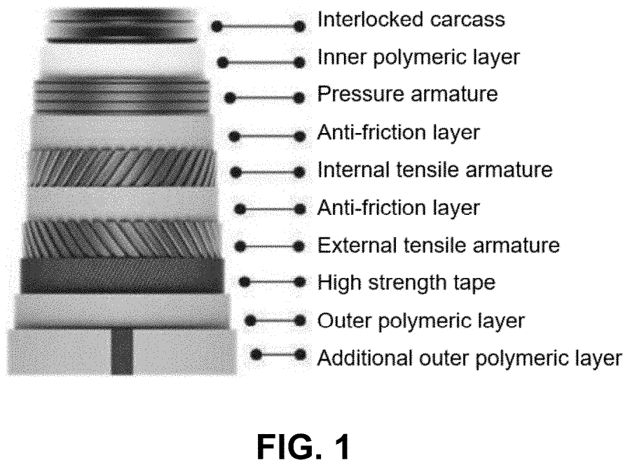

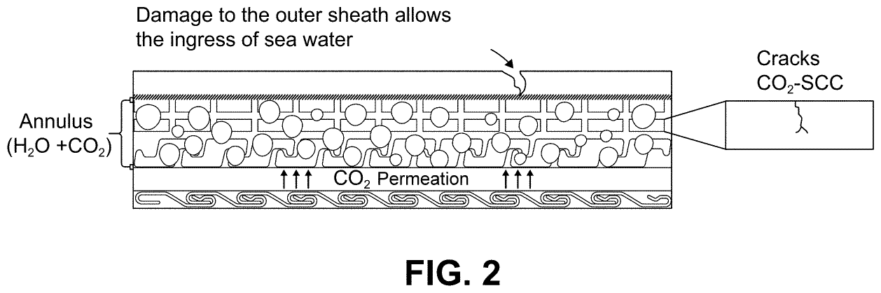

### DETAILED DESCRIPTION OF THE INVENTION

For the CO2-SCC phenomenon to occur, the interaction of four main factors is necessary, namely: a) tensile stress, which can be either static or dynamic, residual or even elastic; b) an enabling environment, i.e., the annulus containing CO₂ and water; c) a susceptible material, that is, one having low tenacity and high mechanical strength, which are subject to the cracking effect; d) and finally the factor time which has an incubation period and a subsequent crack growth, leading to rupture of the layer.

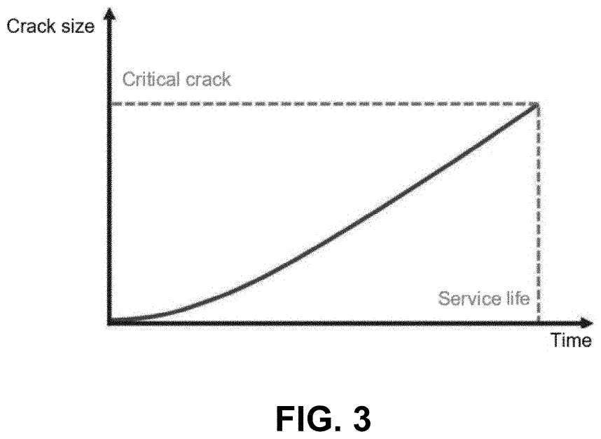

The method of the present invention is intended to achieve the crack growth rate that aims to prevent the advancement of the discontinuity over time, and the critical crack size, which causes rupture of the structural layer wire (for example, tensile or pressure armature). With this information in hand, it is then possible to estimate the time required for rupture of the wire in the layer to occur, as shown schematically in FIG. 3.

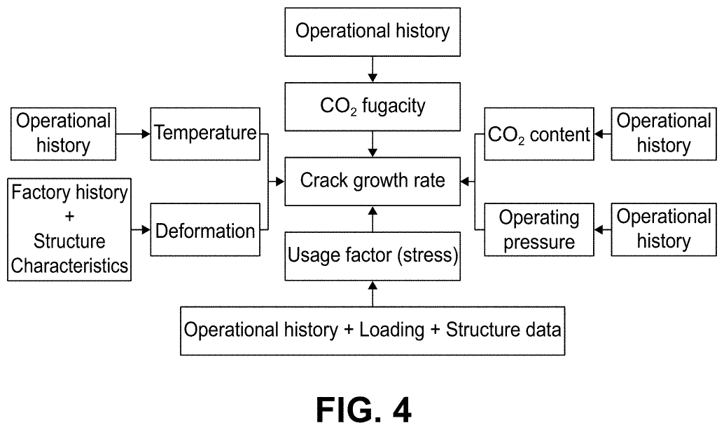

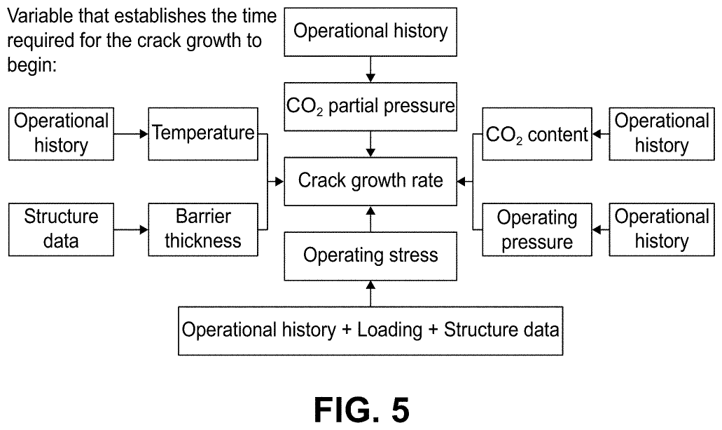

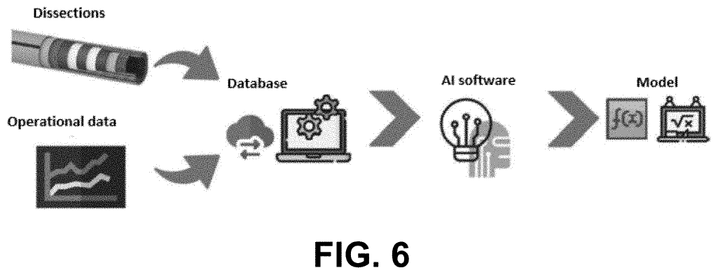

The crack growth rate in structural layers depends on several variables, namely: CO₂ fugacity in the annulus, temperature in the bore of the flexible pipe and external temperature, deformation associated with the manufacturing process of the flexible pipe, CO₂ content of the transported fluid, internal operational pressure and factor of use of the wire of the layer during operation. These variables, in turn, may depend on the operational history, characteristics of the flexible pipe structure, manufacturing history and loads, as shown schematically in FIG. 4. Alternatively, other variables can also be considered to contribute to the crack growth rate, such as: CO₂ partial pressure, operational stress, inner barrier thickness. To correlate so many variables with the crack growth rate, an artificial intelligence (AI) software was required. To feed this software, a database was created that gathers information on dissections of flexible pipes subjected to CO2-SCC and operational data, as shown in FIG. 5. Accordingly, the software searches for a multivariable equation whose answer is the crack growth rate, which, in turn, is a function of operational parameters and structure characteristics.

Then, the methodology used here obtains the crack growth rate, which is influenced by the CO2-SCC and, in the case of risers, also by fatigue, and the point of rupture (critical crack), delimiting the curve, as shown in FIG. 3.

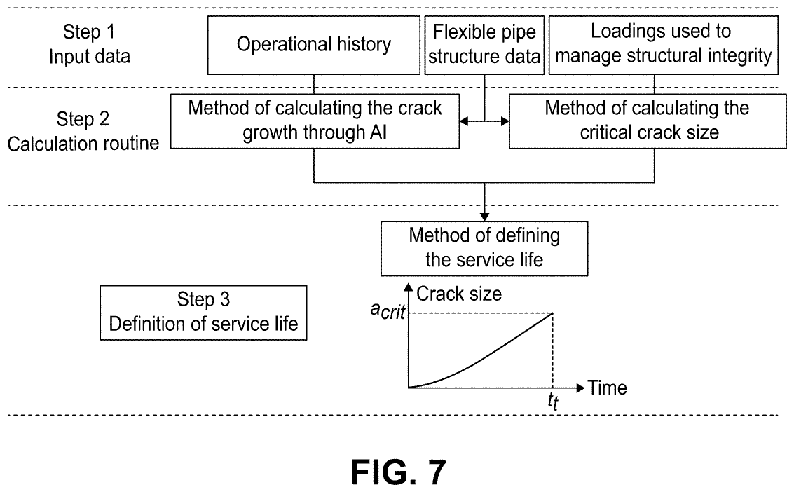

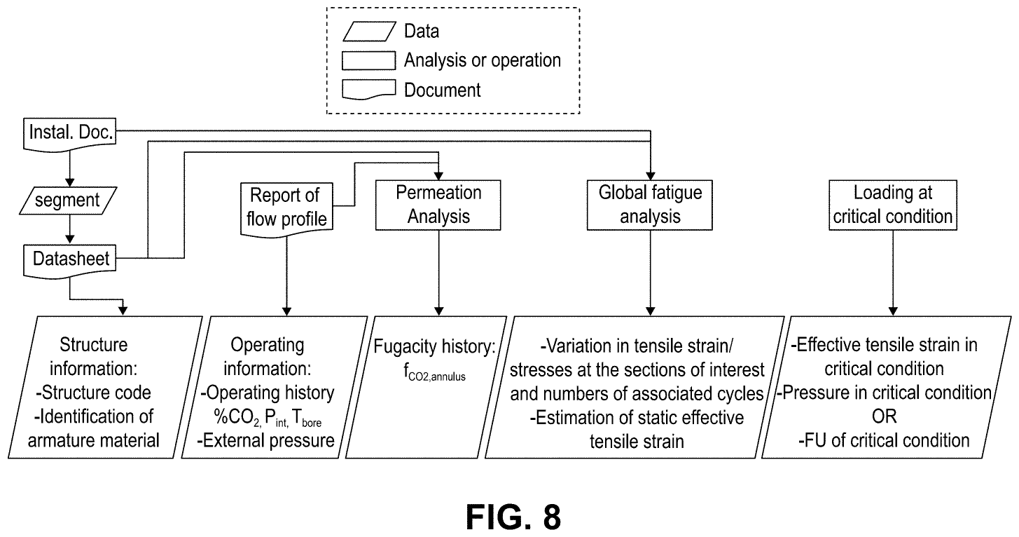

Once the growth rate models due to CO2-SCC have been obtained, a service life calculation method can then be performed, as shown in FIG. 7. The first step of the proposed method consists of gathering all the input data necessary to perform service life calculation, namely, the operational history, structure data and loads used for structural integrity management.

In the second stage, the operational history and flexible pipe structure data serve as input for the crack growth calculation method. An equation with several variables for each structural layer of the flexible pipe is used to estimate the crack growth.

The crack growth predictive model is obtained through an artificial intelligence algorithm that uses data stored in a structured database consisting of dissection data of pipelines subjected to CO₂ stress corrosion and their respective operational histories and structural characteristics. Through this AI algorithm, multivariate equations were determined to estimate the crack growth rate in the tensile armature (TC_{AT}) and pressure armature (TC_{AP}). Such equations are used in step 2 shown in FIG. 7.

The third step of the method consists of defining the service life by applying safety factors to the results achieved in step 2.

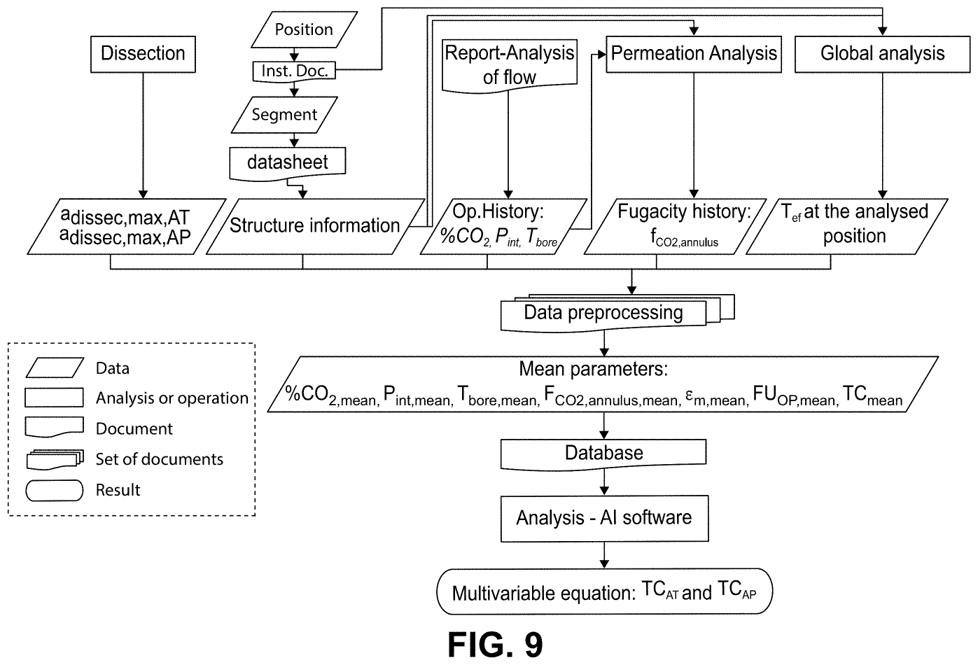

Generation of the database depends on information from different sources, such as dissection data, analysis results and structural characteristics of the flexible pipe. FIG. 9 presents the flowchart for obtaining relevant information for each case. The main points related to the generation of the database and obtaining the multivariate crack growth equations due to CO₂-SCC are highlighted below:

A) Initially, based on the dissected flexible pipe position, the segment is identified from the installation document. From this, the structure data sheet is obtained and geometric data is extracted, as well as some mechanical properties of the material and the flexible pipe, such as yield stress, flowline tensile failure, among others.

B) Upon consulting the flow analysis report, the operational history of internal pressure, fluid temperature and CO₂ content of the drained fluid is obtained. These data together with the structure information are used to perform the permeation analysis, thus obtaining the history of CO₂ fugacity in the annulus.

C). Furthermore, in case of risers, a global analysis is required to obtain the effective tensile strain of the line in the static condition.

D). From dissections of the flexible pipes, it is then possible to obtain the crack sizes found in the tensile and pressure armatures (adisec.AT and adissec.AP, respectively).

E) Thus, for each case in the database, all the information mentioned above is compiled in a processing worksheet. This worksheet processes the input data and then provides the average parameters for each layer (see Table 1).

TABLE 1
Example of output data from a database case

| | | | | | | | | | | | | | |
|---|---|---|---|---|---|---|---|---|---|---|---|---|---|
| | | | | | | Operating | | | | | | | |
| | | | | | | time with | | Average | | | | | |
| | | | | Maxi- | | CO₂ | | temper- | | | | | Average |
| | | | | mum | Total | fugacity | Average | ature | Average | Average | | Average | crack |
| | | | | Crack | operating | above 1 | CO₂ | in the | CO₂ | Internal | | assembly | growth |
| | | Appli- | | Size | time | bar | fugacity | borehole | content | pressure | Average | strain | rate |
| Case | Structure | cation | Section | [μm] | [days] | [days] | [bar] | [° C.] | [%] | [bar] | fugacity | rate | [μm/day] |

Tensile armor

| | | | | | | | | | | |
|---|---|---|---|---|---|---|---|---|---|---|
| Flowline | 2300 | 1046 | 989 | 2.87 | 43.33 | 24.74 | 453.24 | 0.12 | 0.0087 | 2.33 |

Pressure armor

| | | | | | | | | | | |
|---|---|---|---|---|---|---|---|---|---|---|
| Flowline | 1387 | 1046 | 989 | 2.87 | 43.33 | 24.74 | 453.24 | 0.26 | 0.0503 | 1.40 |

F) Once each case is processed, it is entered into the database, as shown in Table 2.

TABLE 2
Database data

| | | | | | % | | |
|---|---|---|---|---|---|---|---|
| | t_{OP} | t_{OP,fCO2,annulus>1} | f_{CO2,annulus,average} | T_{b,average} | CO_{2,average} | P_{int,average} | ε_{m,AT} |
| Case | [days] | [days] | [bar] | [° C.] | [%] | [bar] | [—] |
| | FU_{AT,average} | ε_{m,AP} | FU_{AT,average} | a_{max,AT} | TC_{AT} | a_{max,AP} | TC_{AP} |
| | [—] | [—] | [—] | [μm] | [μm/day] | [μm] | [μm/day] |

G) Finally, through consolidation of the database, analyzes in the AI software are performed to obtain multivariable equations for the tensile and pressure armatures.

As shown earlier, the crack growth rate (TC) by CO₂-SCC depends on several variables. In the model considered in the methodology for using the AI algorithm, the following variables are used: 1) CO₂ content of the transported fluid (% CO₂); 2) Internal pressure (Pint); 3) Layer wire utilization factor during operation (FU_{OP}); 4) Temperature in the flexible pipe bore (Tbore); 5) Deformation associated with the manufacturing process of the flexible pipe (εₘ) 6) CO₂ fugacity in the annulus (fCO₂, annulus).

Alternatively, other variables can be considered, see FIG. 5. In this approach, the following variables are used: 1) CO₂ content of the transported fluid 2) Internal pressure; 3) CO₂ partial pressure in the bore (pipe core—internal diameter section) of the flexible pipe 4) Stress acting on the layer wire during operation; 5) Temperature in the flexible pipe bore; 6) Total internal barrier thickness; 7) CO₂ fugacity in the annulus.

In case of risers, a fraction of crack growth due to fatigue (da/dN) is added to the growth rate for tensile armature wires using the Paris law ((N. E. Dowling, Mechanical Behavior of Materials—Engineering Methods for Deformation, Fracture and Fatigue, 4th Ed., 2013), which is given by

da/dN=CΔK^{m} (1)

Where C and m are material parameters of the tensile armature of a given flexible pipe manufacturer, whose value can be provided by such manufacturer or obtained through material assays. AK corresponds to the variation of the stress intensity factor.

The critical crack calculation is based on the structural integrity standard BS7910: 2015—“Guide to methods for assessing the acceptability of flaws in metallic structures”. To carry out such an evaluation, it is necessary to estimate the stress field acting on the structural layer wire (tensile or pressure armature) and to also consider a certain crack geometry. Thus, using Fracture Mechanics concepts it is possible to establish the crack size capable of causing wire rupture based on material properties and imposed loads.

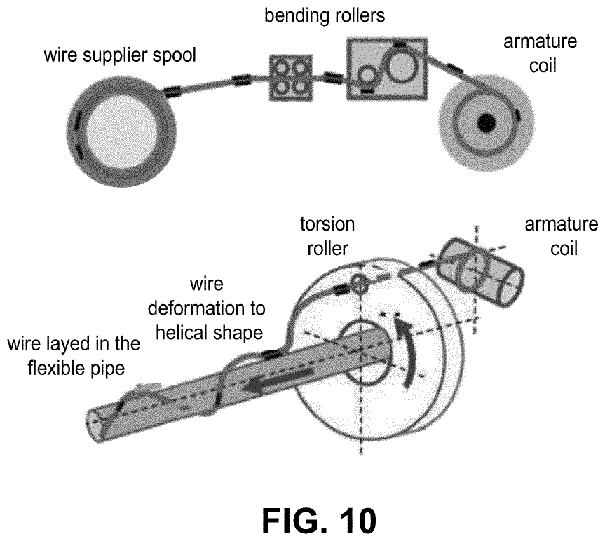

To calculate the crack size, first, one must know the stress field acting on the component. In the case of flexible pipes, during manufacture of the flexible pipe, the metallic layer wires are subjected to a tortuous process of plastic deformation, where bendings in different planes and directions are applied. A schematic example of the flexible pipe manufacturing process focused on the tensile armature wires is shown in FIG. 10. Pressure armature wires go through similar deformation cycles.

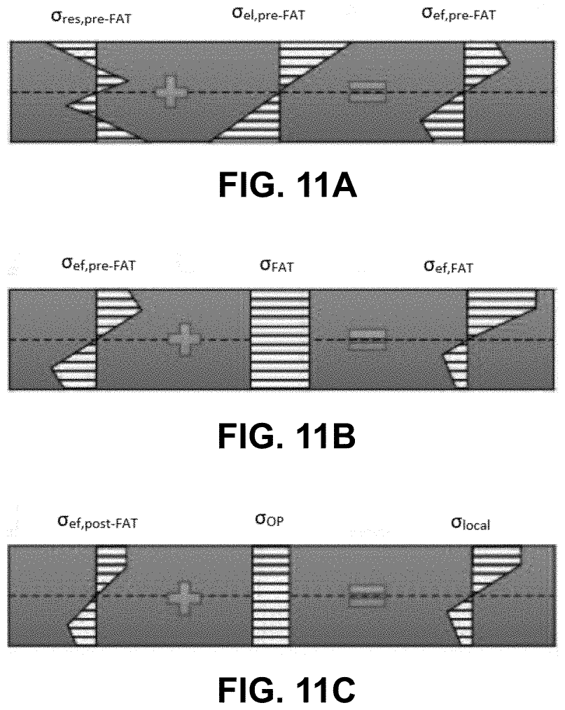

This process ends up generating a complex state of residual stresses on the wires even before the flexible pipe starts operating. At the end of the process, the final laying aims to ensure that the wire is not subjected to any springback. However, from the manufacturing point of view, this control is complex and, in general, the wire laid in the pipe ends up having unknown levels of residual stress as well as a level of stored elastic energy. From the calculation methodology point of view, it is idealized that the effective stress field (σ_{ef, pre-FAT}) acting prior to the factory acceptance test is composed of a residual portion (σ_{res, pre-FAT}) and an elastic portion (σ_{e1, pre-FAT}). This elastic portion is idealized as a bending stress that makes the wire to reach the desired end geometric configuration, while the residual portion is idealized as a self-balancing profile. This is shown schematically in FIG. 11A.

The pipeline manufacturing process is completed when it is subjected to FAT. During this test, the structural layers are subjected to stresses greater than those foreseen in the design condition. These stresses combined with the existing residual and elastic stresses can lead to partial flow of the wire section, as shown in FIG. 11B. Such a localized plastification then leads to a new state of effective stress after the FAT (σ_{ef, post-FAT}), due to the relief of residual stresses. In operation, the pipelines will be subjected to external loads that will be transformed into operational stresses (σ_{OP}), which, in turn, will be added to σ_{ef, post-FAT}. Accordingly, a local stress state (σ_{local}) will be formed in the wire, as shown in FIG. 11C. The operating stress is determined from conservative tensile and pressure values used in the management of the structural integrity of flexible pipelines, which are determined as follows:

A) Tensile strain: obtained from a global analysis in the extreme condition.

B) Internal pressure: maximum pressure values that may occur during operation of the flexible pipeline are adopted.

Considering a point located on the outer surface of the wire, calculation of σ_{ef, post-FAT,AT} is performed in three stages, namely:

A.1) Deformation imposed on the wire during the method of manufacturing and pipe laying (ϵ_{m,AT});

A.2) Total deformation imposed on the wire during FAT (ε_{t,AT}) and achievement of the stress (σ_{ef,FAT,AT}) associated to such deformation;

A.3) Stress relief after FAT from σ_{ef,FAT,AT} and obtaining of σ_{ef,post-FAT,AT}.

The procedure for calculating the critical crack of the pressure armature is quite similar to that adopted for the tensile armature.

### Examples

The following examples are presented to fully illustrate the predictability of the present invention and how to practice the same, without, however, being considered limitative of its content. They are intended to analyze the response of the methodology to the results predicted by the method with actual values. The following assessments were carried out: a) Crack growth rate: the values of maximum crack size predicted by the model were compared with values actually observed from dissected ducts; and b) Service life: in these analyses, the objective is to assess the ability to predict the occurrence or not of failures considering the cases present in the database.

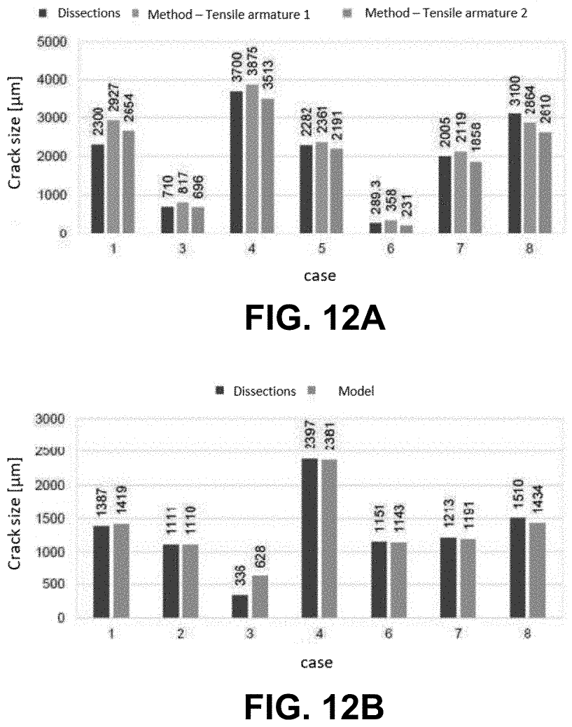

Through the crack growth rate method, it was possible to estimate the predicted final size of the crack considering the cases present in the database that were numbered from 1 to 8, see FIGS. 12A and 12B. Thus, the sizes estimated through the equations were compared with the actual values obtained in the dissection of flexible pipes. FIG. 12A discloses a comparison for the tensile armature, where the predicted values for the internal armature (tensile armature 1) and external armature (tensile armature 2) are presented. It can be noted that the method can predict the crack size with excellent accuracy. The same is seen for the pressure armature by analyzing FIG. 12B.

Consistency of the methodology for service life was assessed for 8 cases present in the database. In some instances, the flexible pipeline failed while in others, the flexible lines were withdrawn before failure occurred. Thus, we observed the prediction of the methodology for the different cases studied. Thus, the ability of the methodology to predict failure and non-failure situations was assessed. This is summarized in Table 3.

As can be seen, the methodology was correct for the vast majority of cases. The only inconsistency was case 2, where the methodology predicted a failure that did not occur in operation. However, this fact, in a way, corroborates that the methodology is conservative.

TABLE 3
Summary of results of the analysis of service life consistency

| Tensile armature | | | Pressure armature | | |
|---|---|---|---|---|---|
| | Actual | | Actual | | |
| Case | situation | Model | situation | Model | Conclusion |
| BD 1 | Failure | Failure | No | No | Consistent |
| | | | failure | failure | methodology. |
| BD 2 | No | Failure | No | No | Conservative |
| | failure | | failure | failure | and consistent |
| | | | | | methodology. |
| BD 3 | No | No | No | No | Consistent |
| | failure | failure | failure | failure | methodology. |
| BD 4 | Failure | Failure | No | No | Consistent |
| | | | failure | failure | methodology. |
| BD 5 | Failure | Failure | No | No | Consistent |
| | | | failure | failure | methodology. |
| BD 6 | No | No | No | No | Consistent |
| | failure | failure | failure | failure | methodology. |
| BD 7 | Failure | Failure | No | No | Consistent |
| | | | failure | failure | methodology. |
| BD 8 | Failure | Failure | No | No | Consistent |
| | | | failure | failure | methodology. |

It should be noted that although the present invention has been described in relation to the attached flowcharts, it may be subjected to minor modifications and adaptations by the skilled person, depending on the specific instance, as long as it is within the scope of the invention as defined herein. A mitigation coefficient in service life calculation, which can be mainly applied to certain applications will be associated with the defined risk levels of the operation

1. A method for estimating the service life of flexible pipes under CO₂ corrosion in oil production characterized by predicting the failure of flexible pipes based on the calculation of the crack growth rate obtained by Artificial Intelligence techniques and on the critical crack estimation.

2. The method, according to claim 1, characterized in that the failure prediction involves a first step which gathers data on operational history, flexible pipe structure and structural integrity loads; a second step gathers the operational history and data from the flexible tube structure serving as inputs for the artificial intelligence algorithm that generates a predictive model of crack growth and in parallel gathers data from the flexible pipe structure and loads of structural integrity for inputs of the critical crack size calculation model, and a third step combines both models and defines a service life predictive model by applying safety factors.

3. The method, according to claim 2, characterized in that the process of preparing the data from the database of the first step consists of:
a) extracting geometric data as well as some mechanical properties of the material and the flexible pipe;
b) obtaining the operational history of internal pressure, fluid temperature and CO₂ content, and consequently, after performing permeation analysis, then obtaining the history of CO₂ fugacity in the annulus;
c) performing global analysis to obtain the effective tensile strain of the line in static condition;
d) obtaining the maximum crack sizes found in tensile and pressure armatures through dissections;
e) all the information mentioned above is compiled in a processing worksheet and average values are obtained for each layer;
f) inputting the data processed in e) into the database.

4. The method, according to claim 2, characterized in that the second step calculates the crack growth rate using the CO₂-SCC and fatigue failure modes.

5. The method, according to claim 2, or characterized in that the second step calculates the crack growth rate using an AI algorithm for the CO₂-SCC failure mode, the calculation methodology consisting of presenting values of the constants of multivariable equations for tensile armature and pressure armature.

6. The method, according to claim 2, characterized in that the second step adds the fatigue failure mode to the crack growth rate if the pipe is a riser, applying to tensile armature wires using equation (1).

7. The method, according to claim 1, characterized in that the critical crack estimation estimates the stress field on the structural layer wire, whether for tensile or pressure armatures, and considering a crack geometry.

8. The method, according to claim 6, characterized by the critical crack estimate for tensile armatures at a point located on the outer surface of the wire, the calculation of the effective stress after FAT being calculated considering the steps of: a) deformation imposed on the wire during the manufacturing process; b) deformation imposed on the wire during FAT and obtaining such associated stress; c) relief of stress after FAT from the previously obtained associated stress and obtaining post-FAT stress.

9. The method, according to claim 6, characterized in that the critical crack estimate for pressure armatures is equivalent to that of the tensile armature.

10. The method, according to claim 7, characterized in that calculation of the operational stress of the critical crack in the tensile armature be composed of tensile strain and internal pressure values, wherein the tensile strain values are obtained through a global analysis of the extreme condition, and the pressure values are adopted for maximum operating values.

11. The method, according to claim 4, characterized in that the second step calculates the crack growth rate using an AI algorithm for the CO₂-SCC failure mode, the calculation methodology consisting of presenting values of the constants of multivariable equations for tensile armature and pressure armature.

12. The method, according to claim 4, characterized in that the second step adds the fatigue failure mode to the crack growth rate if the pipe is a riser, applying to tensile armature wires using equation (1).
